(19) United States
(12) Patent Application Publication
(10) Pub. No.: US 2013/0132335 A1
(43) Pub. Date: May 23, 2013

(54) UPDATING METHOD AND SYSTEM OF APPLICATION SYSTEM DATABASE THEREOF

(71) Applicants: Wei-Hua YANG, Tianjin (CN); Chih-Feng CHEN, Taipei (TW)

(72) Inventors: Wei-Hua YANG, Tianjin (CN); Chih-Feng CHEN, Taipei (TW)

(73) Assignee: INVENTEC CORPORATION, Taipei (TW)

(21) Appl. No.: 13/431,631

(22) Filed: Mar. 27, 2012

(30) Foreign Application Priority Data
Nov. 23, 2011 (CN) 201110409541.6

(51) Int. Cl. G06F 7/00

(52) U.S. Cl. 707/609; 707/E17.005

(57) ABSTRACT

An updating system comprises a registering module, for registering database updating requests required to be executed by an applicant of the application system during an application session, when a same data registered and updated previously is required during a same application session, the same data is acquired from a modified data in a recording module; a recording module, for recording the registered database updating requests and the modified data required for submitting to the database; a submitting module, for submitting the multiple database updating requests when the application session is completed; a merging module, for merging the database updating requests, when multiple times of updating are executed for different fields of a same data by the applicant in the application session, the database updating requests of the same data are merged into one database updating request; and an updating module, for starting database transaction and completing the database update.

### CROSS-REFERENCE TO RELATED APPLICATIONS

This non-provisional application claims priority under 35 U.S.C. §119(a) on Patent Application No(s). 201110409541.6 filed in China, P.R.C. on Nov. 23, 2011, the entire contents of which are hereby incorporated by reference.

### BACKGROUND

1. Technical Field

The present disclosure relates to a technique for enhancing efficiency of an application session at a server end and more particularly to a method and system for enhancing an updating efficiency for a system database.

2. Related Art

In an applied conversation course, a client program executes read and write in a database continuously within a range of a database transaction according to a sequence of operations.

Referring to FIG. 1, according to a sequence of operations, after starting a transaction by an applicant (step 101), the applicant sequentially performs the steps of: writing a data A to a database (step 102), reading a data B (step 103), writing a data C (step 104), reading a data D (step 105), updating a data E (step 106), and finally submitting the transaction (step 107).

The abovementioned method of writing to the database multiple times increases the number of times of accessing the database. And during performing the transactions, if updating of data is carried out according to the method, the database may be lockup.

Referring to FIG. 2, if application sessions are carried out by two applicants A and B at the same time, and a sequence of data updating by the applicant A is A and then B, while a sequence of data updating by the applicant B is B and then A, because the sequences of data updating are different during the transactions, the abovementioned problem of being lockup will occur.

### SUMMARY

According to an embodiment provided by the disclosure, the disclosure provides an updating method of application system database, the updating method includes following steps of:

a) registering database updating requests required to be executed by an applicant of the application system during an application session;

b) recording the registered database updating requests and a modified data required for submitting to the application system database;

c) submitting the database updating requests when the application session is completed;

d) merging the database updating requests; and

e) starting a database transaction and completing the updating of the application system database.

According to another embodiment provided by the disclosure, the disclosure provides an updating system of application system database, the updating system comprises: a registering module, a recording module, a submitting module, a merging module and an updating module. The registering module is used for registering database updating requests required to be executed by an applicant of the application system during an application session, when a same data registered and updated previously is required during a same application session, the same data is acquired from a modified data in a recording module. The recording module is used for recording the registered database updating requests and the modified data required for submitting to the database. The submitting module is used for submitting the multiple database updating requests when the application session is completed. The merging module is used for merging the database updating requests, when multiple times of updating are executed for different fields of a same data by the applicant in the application session, the database updating requests of the same data are merged into one database updating request. The updating module is used for starting a database transaction and completing the database update.

The present invention will become more fully understood by reference to the following detailed description thereof when read in conjunction with the attached drawings.

### BRIEF DESCRIPTION OF THE DRAWINGS

The present disclosure will become more fully understood from the detailed description given herein below for illustration only, and thus are not limitative of the present disclosure, and wherein:

FIG. 1 is a flow chart of a conventional updating method of application system database;

FIG. 2 is a flow chart showing a lockup during a merging of transactions by employing a conventional updating method of application system database;

FIG. 3 is a block diagram of a structure of an updating system of application system database according to an embodiment of the disclosure;

FIG. 4 is an overall flow chart of an updating method of application system database according to an embodiment of the disclosure;

FIG. 5 is a flow chart of the updating method of application system database according to a preferred embodiment of the disclosure; and

FIGS. 6A and 6B are flow charts of a merging of transactions by employing the updating method of application system database according to a preferred embodiment of the disclosure.

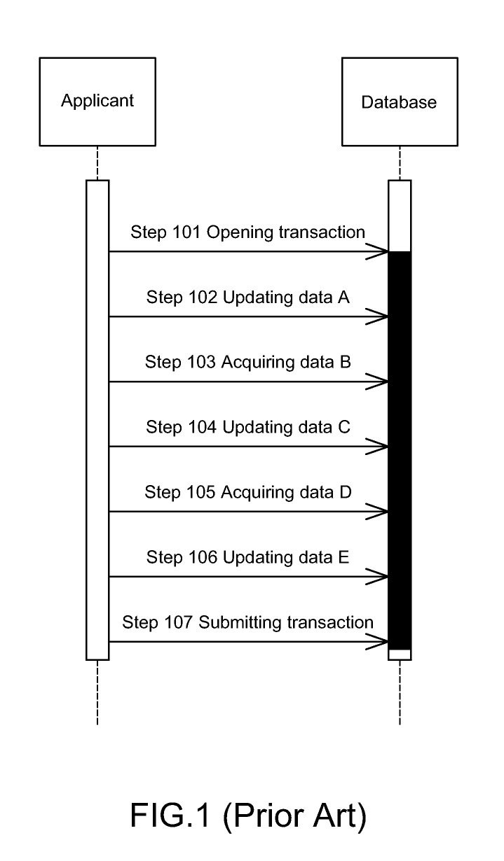

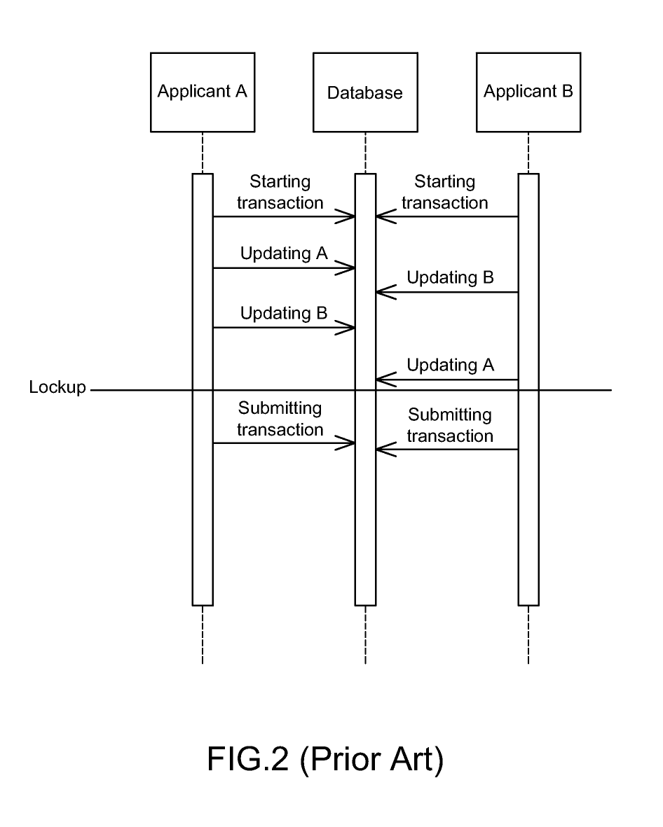

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the disclosure are described in details below, demonstrations of the embodiments are shown in the attached drawings. Throughout the entire descriptions, the same or similar elements, or elements having the same or similar functions are represented by the same or similar numbers. The embodiments described below in accordance with the drawings are only used as examples for explaining the disclosure, but should not be construed as limitations to the disclosure thereof.

In order to solve the abovementioned technical problems, some embodiments of the disclosure provides a method and system for enhancing an updating efficiency of an application system database

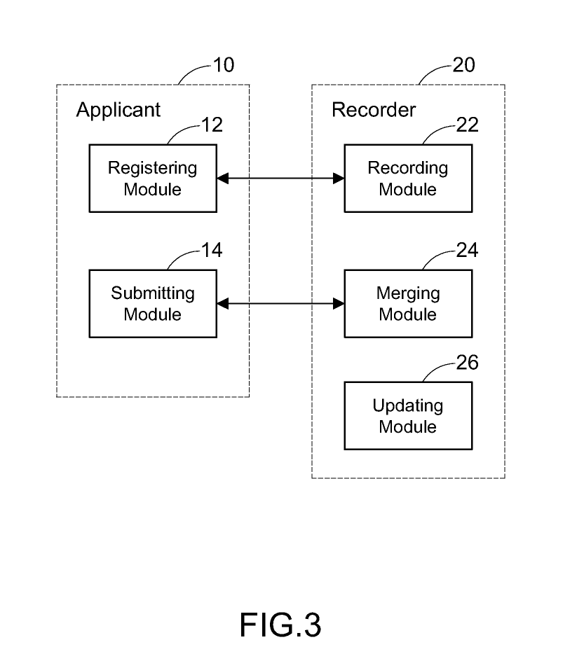

Referring to FIG. 3, FIG. 3 is a block diagram illustrating the structure of an updating system of application system database according to an embodiment of the disclosure.

As shown in FIG. 3, the updating system comprises a registering module 12, a submitting module 14, a recording module 22, a merging module 24 and an updating module 26. Wherein, the registering module 12 and the submitting module 14 are disposed in an applicant 10, while the recording module 22, the merging module 24 and the updating module 26 are disposed in a recorder 20. The applicant 10 and the recorder 20 are operating at a server-side. At the server-side, the applicant 10 is equivalent to a client, while the recorder 20 is equivalent to a server.

The operating principles of the updating system will be described below in details.

The applicant 10 includes a client program, i.e., the registering module 12, which is used to register multiple database updating requests with the recorder 20 required by the applicant 10 of the application system in an application session process.

Correspondingly, the recording module 22 included in the recorder 20 is used for recording multiple database updating requests registered by the registering module 12, and at the same time, recording all the modified data corresponding to the requesting and needed to be submitted to the data base.

When an application session is completed, the submitting module 14 submits the multiple database updating requests to the recorder 20, then the multiple submitted database updating requests are merged by the merging module 24. Multiple times of updating may be executed for different fields of a same database recording by the applicant 10 in an application session. Here, the merging module 24 identifies the multiple updating requests of the same record, and the multiple updating requests are merged into one database updating request. Then, the updating module 26 starts a database transaction and completes the corresponding database update, and finally submits the transaction.

Thereby, the multiple times of writing to the database can be merged, so that the number of times of accessing the database is reduced, and a span of database transactions is also reduced.

In an embodiment, in order to ensure the uniformity of the data, the registering module 12 records the modified data corresponding to the database updating requests. When a same data registered and updated previously is required by the registering module 12 during a same application session, the same data can be acquired from the modified data corresponding to the records in the recording module 22.

In an embodiment, the updating system further comprises a checking module (not shown in the drawings), if at least two applicants are registering or recording database updating requests at the same time, when one of the applicants is submitting a database updating request, the checking module is used for checking if the database updating data required by the current conversation has been modified by the session of the other applicants. If the required database updating data has been modified by other conversations during the current conversation course, then this submission is failed and the transaction executes rollback.

In an embodiment, the updating system further comprises a rules establishing module (not shown in the drawings), if at least two applicants are registering or recording database updating requests at the same time, the rules establishing module is used for establishing pre-defined rules of data updating sequence for the two applicants, so that before each of the applicants executes database updating, the database updating requests required to be executed are arranged in sequence according to the rules, and the updating requests are sent to the database according to the sequence by a corresponding requesting module. Thereby, an executing sequence of writing to the database can be managed conveniently, thus the unnecessary lockups can be avoided.

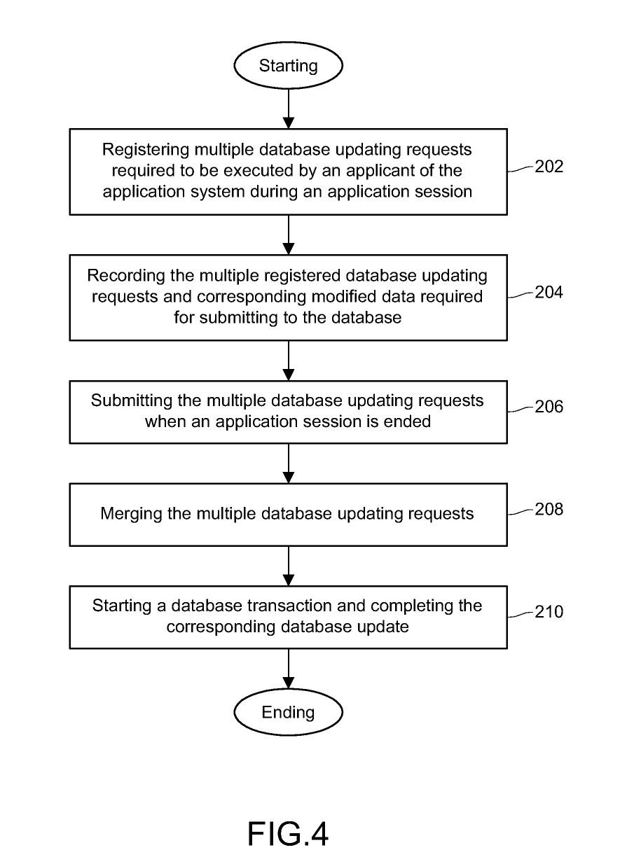

Referring to FIG. 4 for the below descriptions, FIG. 4 is an overall flow chart of an updating method of application system database according to an embodiment of the disclosure. Wherein, definition of the same names described in the method can be referred to the above-mentioned and will not be mentioned herein again.

Firstly, multiple database updating requests required to be executed is registered by an applicant of the application system during an application session (step 202).

Then, the multiple registered database updating requests and corresponding modified data required for submitting to the database are recorded (step 204).

Sequentially, the multiple database updating requests are submitted, when an application session is ended (step 206).

After the submitted updating requests are received, the multiple database updating requests are merged (step 208).

Finally, a database transaction starts and the corresponding database update is complemented (step 210).

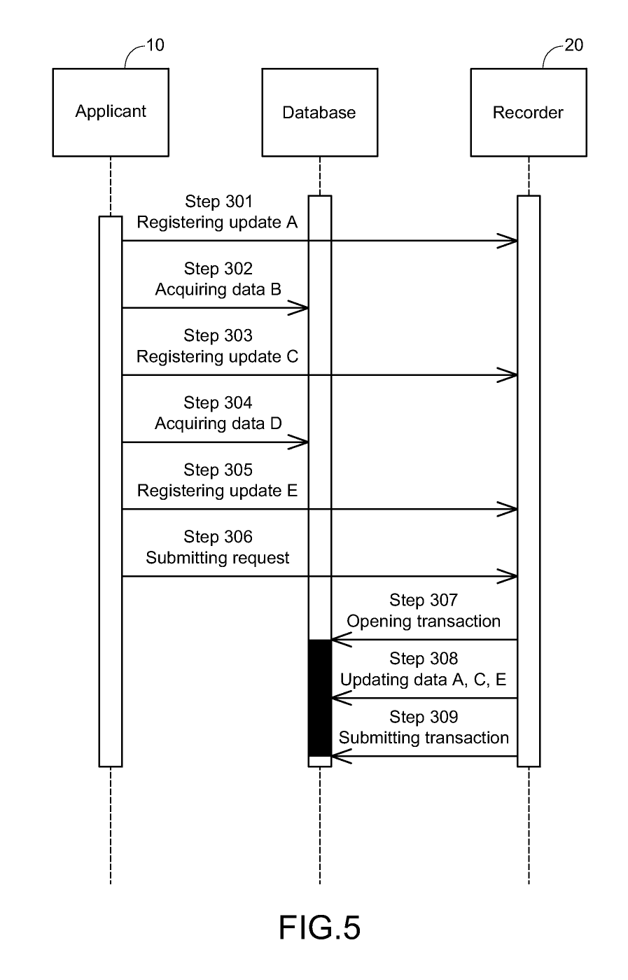

Here, the principles of the updating method of application system database of the disclosure will be described below in details in accordance with a preferred embodiment shown in FIG. 5.

As shown in FIG. 5, when writing to the database is executed, the applicant 10 registers an update A with the recorder 20 (step 301), registers an update C (step 303) and registers an update E (step 305), and then the registered requests of the applicant 10 are merged by the recorder 20. For reading from the database, a data B is acquired directly from the database by the applicant 10 (step 302), and then the reading process of acquiring a data D (step 304) is executed.

Furthermore, in the last stage of an application session, i.e. a submission request is sent to the recorder 20 by the applicant 10 (step 306) after a last reading and writing request is sent, in order to inform the recorder 20 that to submit the data to the database.

The registered requests of the applicant 10 is merged by the recorder 20, and a database transaction is started (step 307), after the submitted requests are received. And then, the data A, C and E is updated, to complete the writing of the corresponding data to the database (step 308). Wherein, multiple times of updating may be executed for different fields of a same database record by the applicant 10 in an application session. The recorder 20 identifies the multiple updating requests of the same record, and the multiple updating requests are merged into one database updating request.

As illustrated in FIG. 5, comparing with conventional updating methods, a recorder is introduced by the disclosure, the recorder records all the modifications required to be submitted to the database. When an applicant needs to update a data, an updating request is registered with the recorder to be recorded, and the applicant attempts to acquire the data from the database. After all the updates are submitted, requests are submitted to the recorder. The multiple database updating requests are merged by the recorder, a transaction is started at a last point-in-time, and then the transaction is submitted.

In order to ensure a uniformity of data, below problems should be noted when applying the updating method:

For the applicant:

If the applicant needs to record a modified data registered with the recorder, and when the applicant requires a same data registered and modified previously with the recorder during a same conversation course, then the data cached with the recorder should be used, but not the data acquired from the database again. For example, the applicant acquires the data A from the database; and then the data A is modified as a data A′; and when the modification is registered with the recorder, the data A′ needs to be retained by the applicant; if the data A is needed to be used again by the applicant in a subsequent processing of a same session, then the data should not be acquired from the database again by the applicant, but the data A′ retained by the applicant should be used instead.

For the recorder:

An optimistic locking mechanism should be used when a modified data is submitted to the database by the recorder, that means when at least two applicants are registering or recording database updating requests at the same time, whether the records required to be updated have been modified by other examples of the recorder as the data is updated should be checked, if the required database updating data has been modified by other conversations during the current conversation course, then this submission is failed and the transaction executes rollback.

If at least two applicants are registering or recording merged transactions of database updating requests at the same time, pre-defined rules of data updating sequence are established for the two applicants, so that before each of the applicants executes database updating, the database updating requests required to be executed are arranged in sequence according to the rules, and the updating requests are sent to the database according to the sequence. Thereby, an executing sequence of writing to the database can be managed conveniently, thus lockups can be avoided.

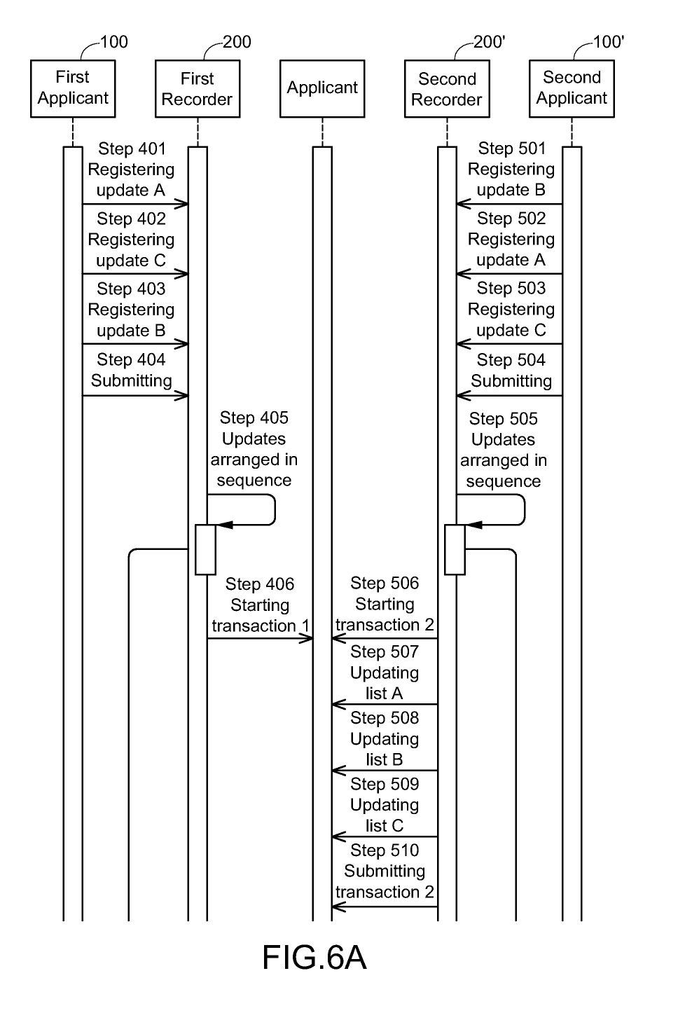

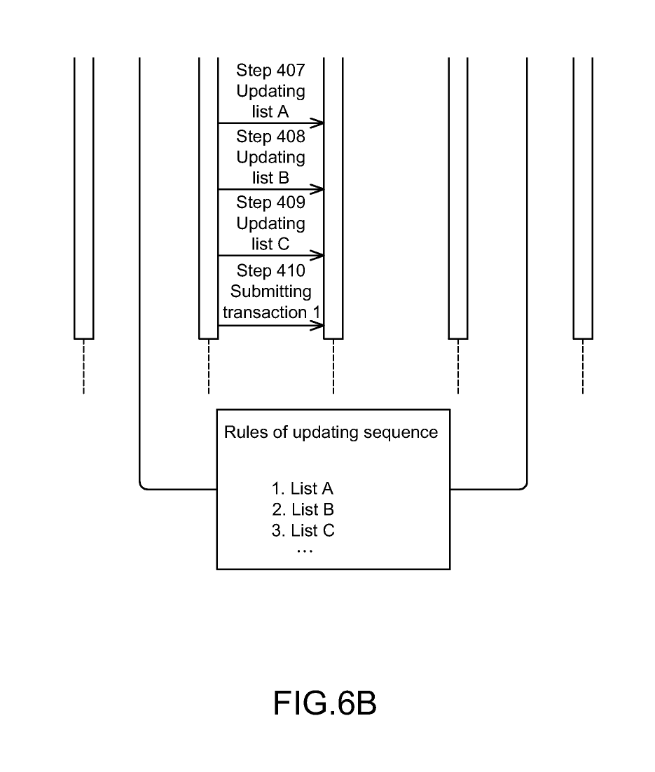

Improvements for lockups is described below in accordance with an embodiment in FIG. 6A and FIG. 6B, FIGS. 6A and 6B are flow charts of a merging of transactions by employing the updating method of application system database according to a preferred embodiment of the disclosure.

A first applicant 100 and a second applicant 100′ are writing data A, B and C to the database in a same application session, only that the updating sequences are different.

As shown in FIG. 6A and 6B, for the first applicant 100 and the second applicant 100′, a first recorder 200 and a second recorder 200′ are imported correspondingly.

The first applicant 100 registers updated data A, C and B with the first recorder 200 in steps 401, 402 and 403, and the requests are submitted when the last session is completed (step 404). Then, before the data in the database are updated by the first recorder 200, the pre-defined rules of data updating sequence are read first and the updating requests required to be executed are arranged in sequence according to the rules (step 405), and then the updating requests are sent to the database according to the sequence, and starting a transaction 1 (step 406). Then, executing steps 407, 408 and 409, updating the transaction with the database, finally submitting the transaction 1 (step 410).

In like manner, the second applicant 100′ registers updated data B, A and C with the second recorder 200′ in steps 501, 502 and 503, and the requests are submitted when the last session is completed (step 504). Then, before the data are updated in the database by the second recorder 200′, the pre-defined rules of data updating sequence are read firstly, and then the updating requests required to be executed are ordered according to the rules (step 505), and the updating requests are sent to the database according to the sequence, and starting a transaction 2 (step 506). Then, steps 507, 508 and 509 are executed, the transaction in the database is excuted, finally the transaction 2 is submitted (step 510).

As shown in FIGS. 6A and 6B, when a record Al on a list A will be updated by the transaction 2, an exclusive lock has to be acquired firstly, and then when the transaction 1 attempts to update the same record, as the data is locked by the transaction 2, the list A can only be updated by the transaction 1 until it is submitted by the transaction 2 and the exclusive lock on the list A is released. Therefore, when all the data in the system is updated according to the pre-defined rules of sequence, the aforementioned lockups can be avoided from occurring effectively.

The multiple times of writing to the database are merged by the disclosure, so that a number of times of accessing the database are reduced, and a span of database transactions is also reduced. Therefore, an updating efficiency of the application system database is enhanced dramatically.

When transactions are executed and updated, rules of data updating sequence are further established, and updating requests required to be executed are ordered according to the rules, so that an executing sequence of writing to the database can be managed conveniently, thus lockups can be avoided from occurring.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An updating method of application system database, comprising:
a) registering database updating requests required to be executed by an applicant of the application system during an application session;
b) recording the registered database updating requests and a modified data required for submitting to the application system database;
c) submitting the database updating requests when the application session is completed;
d) merging the database updating requests; and
e) starting a database transaction and completing the updating of the application system database.

2. The updating method of application system database as claimed in claim 1, wherein the applicant records the modified data in the database updating requests.

3. The updating method of application system database as claimed in claim 1, when the applicant requires a same data registered and updated previously during the same application session, the same data is acquired from the modified data corresponding to the records in the step b.

4. The updating method of application system database as claimed in claim 2, when the applicant requires a same data registered and updated previously during the same application session, the same data is acquired from the modified data corresponding to the records in the step b.

5. The updating method of application system database as claimed in claim 1, wherein if at least two applicants register database updating requests respectively at the same time, when one of the applicants submit a database updating request, checking if the database updating data required by the application session has been modified by another application session of other applicants.

6. The updating method of application system database as claimed in claim 1, wherein if at least two applicants register database updating requests respectively at the same time, pre-defined rules of a data updating sequence are established for the two applicants, so that before each of the applicants executes database updating, the database updating requests required to be executed are arranged in the data updating sequence according to the pre-defined rules, and the updating requests are sent to the database according to the data updating sequence.

7. The updating method of application system database as claimed in claim 1, wherein the step d further includes: when multiple times of updating are executed for different fields of a same data by the applicant in an application session, the multiple database updating requests of the same data are merged into one database updating request.

8. An updating system of application system database, comprising:
a registering module, for registering database updating requests required to be executed by an applicant of the application system during an application session, when a same data registered and updated previously is required during a same application session, the same data is acquired from a modified data in a recording module;
a recording module, for recording the registered database updating requests and the modified data required for submitting to the database;
a submitting module, for submitting the multiple database updating requests when the application session is completed;
a merging module, for merging the database updating requests, when multiple times of updating are executed for different fields of a same data by the applicant in the application session, the database updating requests of the same data are merged into one database updating request; and
an updating module, for starting a database transaction and completing the database update.

9. The updating system of application system database as claimed in claim 8, wherein the registering module records the modified data of the database updating requests.

10. The updating system of application system database as claimed in claim 8, further comprising a checking module, if database updating requests are registered by at least two applicants respectively at the same time, when a database updating request being submitted by one of the applicants, the checking module is used for checking if the database updating data required by the current conversation has been modified by the application sessions of other applicants.

11. The updating system of application system database as claimed in claim 8, further comprising a rules establishing module, if database updating requests are registered by at least two applicants respectively at the same time, the rules establishing module is used for establishing pre-defined rules of data updating sequence for the two applicants, so that before database updating is executed by each of the applicants, the database updating requests required to be executed are arranged in sequence according to the pre-defined rules, and the updating requests being sent to the database according to the sequence by a corresponding requesting module.
